(19) United States
(12) Patent Application Publication
(10) Pub. No.: US 2006/0279729 A1
(43) Pub. Date: Dec. 14, 2006

(54) Method of inspecting semiconductor wafers taking the SAW design into account

(75) Inventors: Michael Heiden, Woelfersheim (DE); Albert Kreh, Solms (DE)

Correspondence Address: HOUSTON ELISEEVA, 4 MILITIA DRIVE, SUITE 4, LEXINGTON, MA, 02421, US

(73) Assignee: Vistec Semiconductor Systems GmbH, Wetzlar (DE)

(21) Appl. No.: 11/409,941

(22) Filed: Apr. 24, 2006

(30) Foreign Application Priority Data
Jun. 10, 2005 (DE) DE 102005027120.0

(51) Int. Cl. G01N 21/88

(52) U.S. Cl. 356/237.5

(57) ABSTRACT

The present invention relates to a method of inspecting a wafer, wherein the wafer has a first area of periodically arranged SAWs and at least one second area of SAWs displaced with respect to the first area. The method comprises the steps of optically imaging the first area of the wafer by moving an imaging window in the period direction, displacing the imaging window relative to the wafer, optically imaging the second area of the wafer by moving the displaced imaging window in the period direction, and evaluating the image by comparing partial images.

### RELATED APPLICATIONS

This application claims priority to German application serial number DE 10 2005 027 120.0 on Jun. 10, 2005, which is incorporated herein by reference in its entirety.

### FIELD OF THE INVENTION

The present invention relates to a method for optically imaging and analyzing wafers having structures produced by SAWs.

### BACKGROUND OF THE INVENTION

The surface of a semiconductor wafer to be inspected comprises dies applied in a structure. A plurality of dies is applied to the wafer with each exposure process. The area of this plurality of dies is the stepper area window (SAW), i.e. the stepper exposure area, which periodically progresses on the surface of the wafer.

A method is known wherein the imaging window of a scanner is scanned along the period progression direction of the SAWs across the wafer. Herein those windows imaged within the distance of the length of a progression period are compared to each other. In a good wafer no differences should arise in this comparison due to the periodic uniformity of the structures. Should there be a defect on the wafer surface, it will show as a difference in the compared images.

To apply the maximum number of semiconductor elements on the wafer, there is usually a displacement of the SAWs in the edge area of the wafer which interrupts the periodicity of the SAWs.

A drawback in the prior art is that intentional deviations from the uniform periodicity of the structures cannot be taken into account in the inspection.

### SUMMARY OF THE INVENTION

It is therefore an object of the present invention to further develop a method of the initially mentioned type in such a way that the optical inspection of a wafer having SAWs in a displaced arrangement can be carried out by simple means.

This object is achieved by a method for inspecting a wafer with a first area of SAWs periodically arranged in a period direction and with at least a second area of SAWs arranged with a displacement of one displacement distance with respect to the first area in a direction normal to the period direction, the object is achieved by the following method steps:
optically detecting a first area of the wafer by moving an imaging window in the period direction across the first area of the wafer until the adjacent second area is reached, and simultaneously imaging partial images in an order following the period direction during the movement,
displacing the imaging window relative to the wafer by one displacement distance in a direction normal to the period direction,
optically imaging the second area of the wafer by moving the displaced imaging window in the period direction across the second area of the wafer, and simultaneously imaging partial images in an order following the period direction during the movement, and evaluating the images by comparing partial images.

The second area can be, for example, the outer area of the surface of a wafer delimited by a chord. Either the imaging window or the wafer or both can be displaced.

According to the invention the above mentioned object is also achieved in a method of inspecting a wafer with a first area of SAWs periodically arranged in a first period direction, and with at least one second area of SAWs periodically arranged in a second period direction normal to the first period direction, by the following method steps:
optically imaging the first area of the wafer by moving an imaging window in the period direction across the first area of the wafer, and simultaneously imaging partial images arranged in the period direction during the movement,
rotating the imaging window relative to the wafer by 90 degrees,
optically imaging the second area of the wafer by moving the displaced imaging window in the period direction across the second area of the wafer, and simultaneously imaging partial images in an order following the period direction during the movement,
evaluating the images by comparing partial images.

The first area and the second area can have a common overlapping area. Either the imaging window or the wafer or both can be moved during the rotation.

Suitably it is provided that partial images having the same period position are compared with each other in the comparing step.

In a good wafer this is advantageous in that essentially identical partial images have to be compared with each other. Usually a difference image is formed. This is especially quick.

Advantageously it is provided that when the partial images are compared, the difference of the partial images is formed.

By forming the difference of the essentially identical partial images a particularly quick comparison of the partial images is possible. Defects show up in that the difference between two partial images is not zero.

Preferably it is provided that the evaluating step is at least partially carried out during the imaging.

This is advantageous in that not the whole image of the wafer has to be intermediately stored in the imaging step, but partial images having the same period position can be compared already after one period length has been intermediately stored. For example, only the overall difference image of the wafer will then be stored in memory.

According to one embodiment of the invention it is provided that essentially the whole width of the wafer is covered by the imaging window in the imaging step.

According to one particular embodiment of the invention it is provided that the imaging window is imaged on a linear array detector in the imaging step.

This is advantageous in that an area of the wafer is imaged in one go according to the manner of a scanner.

It is advantageously provided that the individual images of the linear array detector are imaged as partial images in the imaging step.

The association of a line of the detector to a partial image leads to a particularly efficient memory management. The partial images need not be composed of further sub-partial images.

Ideally it is provided that pixels having the same position in the linear array detector are compared to each other in the evaluating step.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The invention will be explained in more detail in the following with reference to schematic drawings of one embodiment. The same reference numerals will be used in the individual figures to indicate the same elements. In the drawings:

FIG. 1 shows a stepper area window (SAW) with dies,

FIG. 2 shows a wafer with a completely uniform arrangement of SAWs,

FIG. 3 shows the exposure order of the SAWs on the wafer,

FIG. 4 shows a wafer having two areas of periodically arranged SAWs,

FIG. 5 shows a first embodiment of the method according to the present invention, and

FIG. 6 shows a second embodiment of the method according to the present invention.

### DETAILED DESCRIPTION OF THE PREFERRED EMBODIMENTS

FIG. 1 shows a stepper area window (SAW) 20. An SAW is a stepper exposure area. This is the portion of the surface of a semiconductor substrate which is structured during the same exposure process. It comprises one or more dies or other semiconductor elements. In the case shown, for example, four dies 21 “A”, “B”, “C”, and “D” are applied.

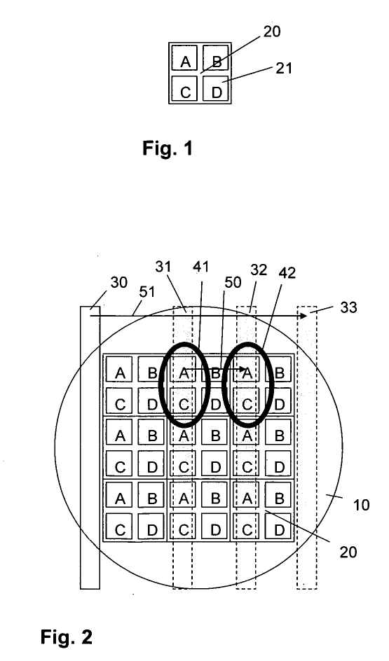

FIG. 2 shows a wafer 10 with SAWs 20 in a fully periodical arrangement. The imaging window 30 of an imaging apparatus, such as a linear array detector, not shown, is depicted overlying the wafer. The imaging window has the width of about the diameter of the wafer, but at least of the extension of the applied SAW structures. It is provided that the imaging window 30 aligned at right angles to the SAW structures is moved across the SAW structures in the movement direction 51. The first position 31, a second position 32, and an end position 33 of the imaging window are shown in the figure across the wafer. The SAWs are periodically arranged on the wafer in a period direction 50. The indicated first viewing area 41 and the second viewing area 42 illustrate the periodicity of repetitive similar dies “A” or “C”. The first position of the imaging window 31 and the second position of the imaging window 32 are spaced at one period length from each other. They therefore image the same SAW structures. Defects in any SAW structure can therefore be detected by a comparison with the other SAW structure. This is the illustrated basic method for inspecting a wafer.

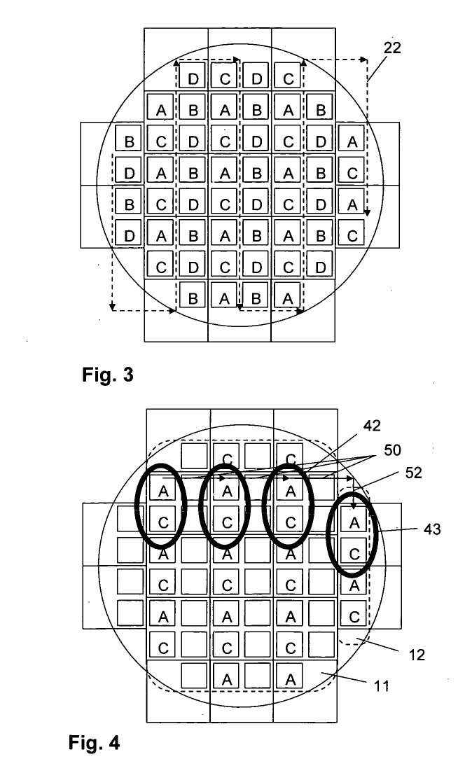

FIG. 3 shows a wafer with applied SAWs and the exposure order 22 of the SAWs. The two SAWs at the beginning and end of each exposure order have their period displaced with respect to the remaining SAWs in order to maximally fill with dies the area cut off by a chord at the edge with two instead of three exposure steps. On the left, dies “B” and “D”, and on the right dies “A” and “C” are applied.

FIG. 4 shows a wafer structured with SAWs and exposed in the manner according to FIG. 3. The SAWs in the first area 11 indicated with broken lines, have a periodicity with respect to each other in the period direction 50. A second area 12, however, also indicated in broken lines, has its periodicity displaced with respect to the first area by one displacement length in a displacement direction 52 normal to the period direction 50 of the first area 11. The displacement is particularly noticeable in the indicated second viewing area 42 and the indicated third viewing area 43.

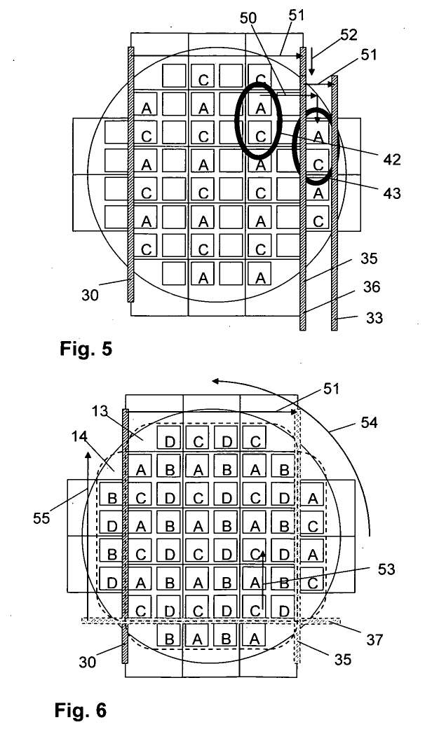

FIG. 5 shows a wafer structured in the manner of FIG. 4 and also visualizes the first method according to the present invention. The narrow imaging window 30 of a linear array detector extending across the whole width of the wafer is in a position at the beginning of the first area. This imaging window 30 is now moved parallel to the period direction 50 of the SAWs in a movement direction 51 up to a first intermediate position 35 at the end of the first area and at the beginning of the second area, for imaging the wafer structures. Following this, the imaging area is displaced from its first intermediate position in a direction normal to its previous movement direction by the displacement length of the SAWs in the second area in a second intermediate position 36. From there the imaging window is further moved in the original movement direction 51 across the second area until its end position 33 at the end of the second area 52 is reached. Herein similar wafer structures or dies always have the same distance from the lateral end of the imaging area or row of the linear array camera; here in the second viewing area 42 and the third viewing area 43 the dies “A” and “C” are shown. This enables an easy comparison of the structures arranged in the second area with those arranged in the first area. By displacing the imaging area at the boundary between the first and second areas, the periodicity interrupted in the exposure by the displacement of the second area with respect to the first area is in a way technically restored in the imaging step.

FIG. 6 shows another wafer structured with SAWs as in FIG. 4. The wafer has a further first area 13 and a further second area 14, each defined by broken lines. The areas are characterized in that within the areas the periodicity of the SAWs is given. The areas partially overlap. The periodicity of the further first area 13 corresponds to the periodicity of the first area 11 of FIG. 4. The periodicity of the further second area 14 is aligned in a vertical, second period direction 53 with respect to the periodicity of the further first area. To do this, the second method according to the present invention provides that the imaging window 13 for imaging the side of the further first area 13 shown on the left in the figure is moved in a direction 51 parallel to the period direction of this area up to the right side of this area in a first process step. In a second step, the wafer is rotated beneath the imaging area about its center axis in the sense of rotation 54 by 90 degrees. This is how the imaging area arrives at its further second intermediate position 37. For clarity, the wafer was not rotated in the figure, but the imaging area is shown as rotated in the reverse direction. Herein the imaging area comes to a position at the one side of the further second area in a direction normal to its period direction. From there the imaging area is moved in the second movement direction 55 for imaging parallel to the second period direction of the further second area in a third method step. In this method only partial images from each same area are compared to each other. While this invention has been particularly shown and described with references to preferred embodiments thereof, it will be understood by those skilled in the art that various changes in form and details may be made therein without departing from the scope of the invention encompassed by the appended claims.

1. A method of inspecting a wafer having a first area of SAWs periodically arranged in a period direction and having at least one second area of SAWs displaced by one displacement length with respect to the first area in a direction normal to the period direction, comprising the steps of:
optically imaging the first area of the wafer by moving an imaging window in the period direction across the first area of the wafer until the adjacent second area is reached, and simultaneously imaging partial images in an order following the period direction during the movement,
displacing the imaging window relative to the wafer by one displacement length in a direction normal to the period direction,
optically imaging the second area of the wafer by moving the displaced imaging window in the period direction across the second area of the wafer, and simultaneously imaging partial images in an order following the period direction during the movement,
evaluating the images by comparing partial images.

2. The method according to claim 1, wherein partial images of the same period position are compared to each other in the evaluating step.

3. The method according to claim 1, wherein a difference of the partial images is formed when the partial images are compared.

4. The method according to claim 1, wherein the evaluating step is carried out at least partially during the imaging step.

5. The method according to claim 1, wherein essentially the whole width of the wafer is covered by the imaging window in the imaging step.

6. The method according to claims 1, wherein the imaging window is imaged on a linear array detector during the imaging step.

7. The method according to claim 6, wherein the individual images of the linear array detector are imaged as partial images during the imaging step.

8. The method according to claim 6, wherein pixels of the same position in the linear array detector are compared to each other in the evaluating step.

9. A method of inspecting a wafer having a first area of SAWs periodically arranged in a first period direction and having at least one second area of SAWs periodically arranged in a second period direction normal to the first period direction, comprising the steps of:
optically imaging the first area of the wafer by moving an imaging window in the period direction across the first area of the wafer, and simultaneously imaging partial images in an order following the period direction during the movement,
rotating the imaging window by 90 degrees relative to the wafer,
optically imaging the second area of the wafer by moving the displaced imaging window in the period direction across the second area of the wafer, and simultaneously imaging partial images in an order following the period direction during the movement,
evaluating the images by comparing partial images.

10. The method according to claim 9, wherein partial images of the same period position are compared to each other in the evaluating step.

11. The method according to claim 9, wherein a difference of the partial images is formed when the partial images are compared.
